(19) United States
(12) Patent Application Publication
(10) Pub. No.: US 2017/0369819 A1
(43) Pub. Date: Dec. 28, 2017

(54) REMOVAL OF HYDROPHILIC BODY SOILS

(71) Applicant: The Procter & Gamble Company, Cincinnati, OH (US)

(72) Inventors: Francesco DE BUZZACCARINI, Breendonk (BE); Xinbei SONG, Cincinnati, OH (US); William Mario Laurent VERSTRAETEN, Herent (BE)

(21) Appl. No.: 15/631,063

(22) Filed: Jun. 23, 2017

Related U.S. Application Data
(60) Provisional application No. 62/354,834, filed on Jun. 27, 2016.

(51) Int. Cl. C11D 3/33; C11D 11/00; C11D 3/395

(52) U.S. Cl. CPC C11D 3/33; C11D 3/395; C11D 11/0064

(57) ABSTRACT

Aminocarboxylate builders having 1 to 3 amino groups and 2 to 6 carboxylic acid groups improve blood soil removal, particularly from fabrics. Improved removal of body soils from fabrics is achieved by washing the fabric in a first wash liquor comprising one or more carboxylate builders, followed by a second wash in a wash liquor comprising surfactant.

### FIELD OF THE INVENTION

Treatment of fabrics to reduce or eliminate hydrophilic body soils.

### BACKGROUND OF THE INVENTION

The human body emits a variety of secretions. Many of these, including sebum, collars and cuff soils, pillow case dinginess, are greasy and hydrophobic. For instance, sebum is a greasy, wax-like secretion from the sebaceous gland. The removal of such hydrophobic stains is greatly improved by the addition of surfactants, grease removal polymers and the like. However, other body soils are hydrophilic, such as blood, menstrual fluid, urine, fecal, perspiration, vomit, mucus, and the like. Stains comprising such hydrophilic body soils are typically highly visible. In both the domestic and professional laundry washing applications, such hydrophilic body soils remain challenging to completely remove, since surfactants alone are often not able to fully remove tough, in-grained hydrophilic body soil stains, and grease removal polymers have limited efficacy on such stains. In addition, while enzymatic action improves the removal of such hydrophilic body soils, they have more limited effectiveness unless the hydrophilic body soil is first lifted off the fabric fibres.

Therefore, a need remains for improvements in the removal of such hydrophilic body soils from fabrics, both in the domestic wash context and also during professional laundry washing. US 2013/0017989 A1 relates to a builder composition which includes a chelating component, a builder component, a polymeric component, and optionally an alkali component and/or a phosphorous-containing component. The chelating component can be methylglycine-N—N-diacetic acid (MGDA) or alkali salt thereof, N,N-bis(carboxymethyl)-L-glutamate (GLDA) or an alkali salt thereof, or ethylenediaminetetraacetic acid (EDTA) or an alkali salt thereof.

### SUMMARY OF THE INVENTION

The present invention relates to the use of a carboxylate builder selected from the group consisting of: aminocarboxylate builders having 1 to 3 amino groups and 2 to 6 carboxylic acid groups, and mixtures thereof, in a laundry composition for removing hydrophilic body soils.

The present invention further relates to a method for removing hydrophilic body soils, from fabrics comprising the step of: washing the fabrics in a first wash liquor, the first wash comprising a carboxylate builder selected from the group consisting of: aminocarboxylate builders having 1 to 3 amino groups and 2 to 6 carboxylic acid groups, and mixtures thereof; and water.

### DETAILED DESCRIPTION OF THE INVENTION

Improved removal of hydrophilic body soils can be achieved through the use of a carboxylate builder selected from the group consisting of: aminocarboxylate builders having 1 to 3 amino groups and 2 to 6 carboxylic acid groups, and mixtures thereof, especially when followed by a subsequent wash with a detersive wash solution.

Builders are water softeners. Builders are typically added to laundry compositions, such as laundry detergent compositions or laundry additives, in order to remove calcium ions by complexation or precipitation. As such, they prevent calcium ions from interfering with the cleaning efficacy of detersive surfactants. It has surprisingly been found that the carboxylate builders also improve the removal of hydrophilic body soils under hard water conditions, but when water having low water hardness or even no water hardness is used for laundering.

All percentages, ratios and proportions used herein are by weight percent of the composition, unless otherwise specified. All average values are calculated “by weight” of the composition or components thereof, unless otherwise expressly indicated.

All measurements are performed at 25° C. unless otherwise specified.

Unless otherwise noted, all component or composition levels are in reference to the active portion of that component or composition, and are exclusive of impurities, for example, residual solvents or by-products, which may be present in commercially available sources of such components or compositions.

### Carboxylate Builder

Suitable carboxylate builders are aminocarboxylate builders having 1 to 3 amino groups and 2 to 6 carboxylic acid groups. Such builders have been surprisingly found to be especially effective at removing hydrophilic body soils. Such hydrophilic body soils include: blood, menstrual fluid, urine, fecal, perspiration, vomit, mucus, and combinations thereof. The carboxylate builder is particularly effective are removing blood from fabrics.

The carboxylate builder can be selected from the group consisting of: glutamic acid N,N diacetic acid (GLDA), methylglycine diacectic acid (MGDA), ethylene diamine tetracetic acid (EDTA), diethyl triamine pentacetic acid (DTPA), nitrilo triacetic acid (NTA), ethylenediamine disuccinic acid (EDDS), imino disuccinic acid (IDS), iminodiacetic acid (IDA), ethanol diglycinate (EDG), aspartic acid N,N-diacetic acid (ASDA), hydroxyethylethylenediamine triacetate (HEDTA), hydroxyethyliminodisuccinate (HIDS), hydroxyethyliminodiacetate (HEIDA), and mixtures thereof. Particularly suitable carboxylate builders can be selected from the group consisting of: N,N diacetic acid (GLDA), methylglycine diacectic acid (MGDA), and mixtures thereof.

The carboxylate builder is present in a laundry composition at a level of from 1 to 50%, preferably from 5 to 40%, more preferably from 15 to 40% by weight of the composition.

The laundry composition can be solid or liquid, and can be formed into a unit dose article, for instance, by encapsulating in a water-soluble film. As used herein, “liquid laundry composition” refers to any laundry treatment composition comprising a fluid capable of wetting and cleaning fabric e.g., clothing, in a domestic washing machine. Such liquid compositions can include solids or gases in suitably subdivided form, but the overall composition excludes product forms which are nonfluid overall, such as tablets or granules. The liquid laundry compositions preferably have densities in the range from 0.9 to 1.3 grams per cubic centimetre, more specifically from 1.00 to 1.10 grams per cubic centimetre, excluding any solid additives but including any bubbles, if present. Liquid laundry compositions are preferred since dosing is simpler, especially for professional laundry systems which comprise an automatic dosing system. In addition, liquid laundry compostions do not require time for dissolution, which means that they have more time to perform during the wash.

The laundry composition can comprise a laundry adjunct selected from the group consisting of: detersive surfactants, enzymes, cleaning polymer, additional builder or chelant, soil release polymer, whitening or blueing agent, antibacterial or disinfecting agent, solvent or stabilizer, perfume, dye or aesthetic additive, and mixtures thereof.

Suitable detersive surfactants include: anionic surfactant, non-ionic surfactant, and mixtures thereof. The laundry composition can comprise the detersive surfactant at a level of from 1 wt % to 70 wt %, preferably from 10 wt % to 40 wt %, more preferably from 15 wt % to 30 wt %.

The detersive surfactant typically comprises anionic surfactant. In preferred laundry compositions, the detersive surfactant can comprise the anionic surfactant at a level of from 1 wt % to 50 wt %, preferably from 10 wt % to 40 wt %, more preferably from 15 wt % to 30 wt %.

Suitable anionic surfactants can be selected from the group consisting of: alkyl sulphates, alkyl ethoxy sulphates, alkyl sulphonates, alkyl benzene sulphonates, fatty acids and their salts, and mixtures thereof. However, by nature, every anionic surfactant known in the art of detergent compositions may be used, such as disclosed in “Surfactant Science Series”, Vol. 7, edited by W. M. Linfield, Marcel Dekker. However, the laundry composition preferably comprises at least a sulphonic acid surfactant, such as a linear alkyl benzene sulphonic acid, but water-soluble salt forms may also be used. Anionic surfactant(s) are typically present at a level of from 1.0% to 70%, preferably from 5.0% to 50% by weight, and more preferably from 10% to 30% by weight of the laundry composition.

Anionic sulfonate or sulfonic acid surfactants suitable for use herein include the acid and salt forms of linear or branched C5-C20, more preferably C10-C16, more preferably C11-C13 alkylbenzene sulfonates, C5-C20 alkyl ester sulfonates, C6-C22 primary or secondary alkane sulfonates, C5-C20 sulfonated polycarboxylic acids, and any mixtures thereof, but preferably C11-C13 alkylbenzene sulfonates. The aforementioned surfactants can vary widely in their 2-phenyl isomer content.

Anionic sulphate salts suitable for use in the compositions of the invention include the primary and secondary alkyl sulphates, having a linear or branched alkyl or alkenyl moiety having from 9 to 22 carbon atoms or more preferably 12 to 18 carbon atoms. Also useful are beta-branched alkyl sulphate surfactants or mixtures of commercial available materials, having a weight average (of the surfactant or the mixture) branching degree of at least 50%.

Other suitable anionic surfactants for use herein include fatty methyl ester sulphonates and/or alkyl alkoxylated sulphates such as alkyl ethyoxy sulphates (AES) and/or alkyl polyalkoxylated carboxylates (AEC).

The anionic surfactants can be present in the form of their salts with alkanolamines or alkali metals such as sodium and potassium.

The laundry composition can comprise nonionic surfactant. The level of nonionic surfactant in the laundry composition can be present at a level of less than 10 wt %, preferably less than 5 wt %, more preferably less than 1 wt %, most preferably less than 0.5 wt %.

Suitable nonionic surfactants include, but are not limited to C12-C18 alkyl ethoxylates (“AE”) including the so-called narrow peaked alkyl ethoxylates and C6-C12 alkyl phenol alkoxylates (especially ethoxylates and mixed ethoxy/propoxy), block alkylene oxide condensate of C6-C12 alkyl phenols, alkylene oxide condensates of C8-C22 alkanols and ethylene oxide/propylene oxide block polymers (Pluronic—BASF Corp.), as well as semi polar nonionics (e g, amine oxides and phosphine oxides) can be used in the present compositions. An extensive disclosure of these types of surfactants is found in U.S. Pat. No. 3,929,678, Laughlin et al., issued Dec. 30, 1975.

Alkylpolysaccharides such as disclosed in U.S. Pat. No. 4,565,647 Llenado are also useful nonionic surfactants. Also suitable are alkyl polyglucoside surfactants.

In some embodiments, nonionic surfactants of use include those of the formula R₁(OC₂H₄)ₙOH, wherein R₁ is a C10-C16 alkyl group or a C8-C12 alkyl phenyl group, and n is from preferably 3 to 80. In some embodiments, the nonionic surfactants may be condensation products of C12-C15 alcohols with from 5 to 20 moles of ethylene oxide per mole of alcohol, e.g., C12-C13 alcohol condensed with 6.5 moles of ethylene oxide per mole of alcohol

The laundry composition can comprise a zwitterion. The zwitterion can be present at a level of from 0.1 wt % to 5 wt %, preferably from 0.2 wt % to 2 wt %, more preferably from 0.4 wt % to 1 wt %. Zwitterionic detersive surfactants include those which are known for use in hair care or other personal care cleansing. Non-limiting examples of suitable zwitterions are described in U.S. Pat. No. 5,104,646 (Bolich Jr. et al.), U.S. Pat. No. 5,106,609 (Bolich Jr. et al.). Zwitterionic detersive surfactants are well known in the art, and include those surfactants broadly described as derivatives of aliphatic quaternary ammonium, phosphonium, and sulfonium compounds, in which the aliphatic radicals can be straight or branched chain, and wherein one of the aliphatic substituents contains from 8 to 18 carbon atoms and one contains an anionic group such as carboxy, sulfonate, sulfate, phosphate or phosphonate. Betaines are also suitable zwitterinic surfactants.

Particularly preferred zwitterions are zwitterionic polyamines. Suitable zwitterionic polymers can be comprised of a polyamine backbone wherein the backbone units which connect the amino units can be modified by the formulator to achieve varying levels of product enhancement, inter alia, boosting of clay soil removal by surfactants, greater effectiveness in high soil loading usage. In addition to modification of the backbone, the formulator may preferably substitute one or more of the backbone amino unit hydrogens by other units, inter alia, alkyleneoxy units having a terminal anionic moiety. In addition, the nitrogens of the backbone may be oxidized to the N-oxide. Preferably at least two of the nitrogens of the polyamine backbones are quaternized. Suitable enzymes provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, and known amylases, or combinations thereof. A preferred enzyme combination comprises a cocktail of conventional detersive enzymes such as protease, lipase, cutinase and/or cellulase in conjunction with amylase. Detersive enzymes are described in greater detail in U.S. Pat. No. 6,579,839.

Enzymes can be stabilized using any known stabilizer system such as calcium and/or magnesium compounds, boron compounds and substituted boric acids, aromatic borate esters, peptides and peptide derivatives, polyols, low molecular weight carboxylates, relatively hydrophobic organic compounds [e.g. certain esters, diakyl glycol ethers, alcohols or alcohol alkoxylates], alkyl ether carboxylate in addition to a calcium ion source, benzamidine hypochlorite, lower aliphatic alcohols and carboxylic acids, N,N-bis(carboxymethyl) serine salts; (meth)acrylic acid-(meth)acrylic acid ester copolymer and PEG; lignin compound, polyamide oligomer, glycolic acid or its salts; poly hexa methylene bi guanide or N,N-bis-3-amino-propyl-dodecyl amine or salt; and mixtures thereof.

Suitable cleaning polymers provide for broad-range soil cleaning of surfaces and fabrics and/or suspension of the soils. Any suitable cleaning polymer may be of use. Useful cleaning polymers are described in USPN 2009/0124528A1. Non-limiting examples of useful categories of cleaning polymers include: amphiphilic alkoxylated grease cleaning polymers; clay soil cleaning polymers; soil release polymers; and soil suspending polymers.

The laundry composition can comprise from 0.6% to 10%, preferably from 2 to 7% by weight of one or more additional builders and/or chelants. Suitable additional builders and/or chelants can be selected from the group consisting of: citric acid, aminoalkylenepoly(alkylene phosphonates), alkali metal ethane 1-hydroxy disphosphonates, and nitrilotrimethylene, phosphonates, diethylene triamine penta (methylene phosphonic acid) (DTPMP), ethylene diamine tetra(methylene phosphonic acid) (DDTMP), hexamethylene diamine tetra(methylene phosphonic acid), hydroxy-ethylene 1,1 diphosphonic acid (HEDP), hydroxyethane dimethylene phosphonic acid, catechol sulfonates such as Tiron™ and mixtures thereof. Preferably, the laundry composition comprises one or more additional builders and/or chelants, more preferably selected from the group consisting of citric acid, and salts thereof. The combination of the aminocarboxylic acid builder and one or more additional builders and/or chelants, especially citric acid and salts thereof, results in an improved balance of both hydrophilic and hydrophobic body soil removal, such as is typically found in collar and cuff stains.

The laundry composition can comprise solvent, such as one or more non-aminofunctional solvents. As used herein, “non-aminofunctional organic solvent” refers to any solvent which contains no amino functional groups, indeed contains no nitrogen. Non-aminofunctional solvent include, for example: C1-C5 alkanols such as methanol, ethanol and/or propanol and/or 1-ethoxypentanol; C2-C6 diols; C3-C8 alkylene glycols; C3-C8 alkylene glycol mono lower alkyl ethers; glycol dialkyl ether; lower molecular weight polyethylene glycols; C3-C9 triols such as glycerol; and mixtures thereof. More specifically non-aminofunctional solvent are liquids at ambient temperature and pressure (i.e. 21° C. and 1 atmosphere), and comprise carbon, hydrogen and oxygen.

For improved removal of hydrophilic stains, the laundry composition has a pH of from 5.0 to 9.0, preferably from 6.0 to 8.0, more preferably from 6.5 to 7.5. The pH is measured, at 25° C., using a Santarius PT-10P pH meter with gel-filled probe (such as the Toledo probe, part number 52 000 100), calibrated according to the instructions manual.

### Method for Removing Hydrophilic Body Soils:

The carboxylate builders are particularly suited for use in methods for removing hydrophilic body soils, such as blood, menstrual fluid, urine, fecal, perspiration, vomit, mucus, and combinations thereof, from fabrics, especially for removing blood.

In preferred methods, a first wash solution is prepared which comprises the carboxylate builder selected from the group consisting of: aminocarboxylate builders having 1 to 3 amino groups and 2 to 6 carboxylic acid groups, and mixtures thereof; and water.

The first wash solution can be prepared by diluting a laundry composition, comprising the carboxylate builder, in water. Preferably, the wash solution is prepared by diluting the laundry composition by a dilution factor of from 0.01 wt % to 5 wt %, preferably from 0.02 wt % to 1.0 wt %, more preferably from 0.05 wt % to 0.3 wt % of the laundry composition in water. The first wash liquor can comprise the carboxylate builder at a level of from 30 to 10000 ppm, preferably from 200 to 5000 ppm, more preferably from 500 to 1500 ppm.

The aminocarboxylate builder improves the removal of hydrophilic body soils also during low temperature washing. As such, the first wash liquor can have a temperature of from 10 to 60° C., preferably from 20 to 40° C., more preferably from 20 to 35° C.

The first wash liquor can comprise one or more additional builders and/or chelants, preferably selected from the group consisting of citric acid, and salts thereof. When present, the first wash liquour can comprise the one or more additional builders and/or chelants at a level of from 10 ppm to 300 ppm, preferably from 30 ppm to 150 ppm.

Surprisingly, the removal of the hydrophilic body soil is particularly effective when the fabric is subsequently washed in a second wash liquor comprising the detersive surfactant. It is believed that the first wash liquor, comprising the carboxylate builder, is able to better loosen the hydrophilic body soil from the fabric fibres such that they are more effectively removed by the subsequent surfactant-containing wash liquor. The second wash liquor can comprise surfactant at a level of from 10 to 3000 ppm, preferably 30 to 1000, more preferably from 100 to 600 ppm.

The second wash liquor can comprise further cleaning ingredients, such as one or more cleaning ingredients selected from the group consisting of: detersive surfactants, enzymes, cleaning polymer, additional builder or chelant, soil release polymer, whitening or blueing agent, antibacterial or disinfecting agent, solvent or stabilizer, perfume, dye or aesthetic additive, bleach, and mixtures thereof. Preferably, the second wash liquor comprises bleach.

The second wash liquor can be at any suitable temperature, such as from 30 to 90° C., or from 40 to 80° C., or from 50 to 70° C.

The method of the present invention can also comprise a spin step after the first wash step but before the second wash step, or after the second wash step, or a combination thereof.

### EXAMPLES

### Example 1

The efficacy of compositions comprising an aminocarboxylate builder having from 1 to 3 amino groups and 2 to 6 carboxylic acid groups (methylglycine diacetic acid, MGDA) in a laundry composition was evaluated on hydrophilic body soils and hydrophobic (greasy) soils.

The test was carried out using identical professional washing machines (Electrolux W365H) and 6 kg of dry fabric load, using standardized stain swatches (stained cotton swatches, obtained from Equest Warwick Ltd or from Center For Test Materials BV) and a 3 kg mixed ballast load. The washes were single bath washes, run at 40° C. with water having a hardness of 2.3 to 2.5 mmol/1 (13-14° dH).

The stain fabrics were graded using a Hunter Colorquest Spectrophotometer to determine the removal of the stains by measuring the amount of stain that is left after washing, compared to the initial unwashed set. The results of the stain removal data were averaged for each stain and each product to give the overall stain removal index (SRI) grade vs. the reference product. The response was measured at 460 nm and used to calculate the soil removal delta in % (ΔSR) according to formula below:

$$Δ SR = \frac{{R}_{before} - {R}_{after}}{{R}_{before} - {R}_{clean}} \times 100 \%$$

R_{before}=Remission before washing
R_{after}=Remission after washing
R_{clean}=Remission from clean white cotton

The comparative liquid detergent composition (laundry composition A) had the same composition as the commercial Ariel Liquid Detergent (Procter & Gamble professional System #1), and was dosed at 10 ml/kg of nominal dry laundry weight (i.e. 60 ml). The Ariel Liquid used in the test comprised 3.4% of citric acid, and no aminocarboxylate builder.

Composition B was the same as composition A, with the addition of 30 wt % of MGDA.

TABLE 1

| | Compo- | Compo- |
|---|---|---|
| | sition A* | sition B |
| wt % MGDA | 0 | 30 |
| wt % Citric acid | 3.4 | 3.4 |
| | SRI | ΔSRI |
| Hydrophilic body soils: | | |
| Blood (aged) knitted cotton | 44.0 | +19.6 |
| Blood/milk/ink, knitted cotton | 19.8 | +18.6 |
| Greasy soils | | |
| Black shoe polish, knitted cotton | 62.5 | +2.5 |
| Dirty motor oil, knitted cotton | 78.8 | −5.7 |
| Bacon grease, knitted cotton | 62.1 | +2.1 |

*comparative

The test shows that compositions comprising an aminocarboxylate builder having from 1 to 3 amino groups and 2 to 6 carboxylic acid groups (methylglycine diacetic acid, MGDA), in a laundry composition, are better at removing hydrophilic body soils such as blood, in comparison to the removal of hydrophobic (greasy) soils.

Composition C was the same as composition A, with the addition of 15 wt % of MGDA and 15 wt % of citric acid. Comparative composition D was the same as composition A, with the addition of 30 wt % of citric acid, neutralized to pH 8.0+/−0.2 with sodium hydroxide.

The collar soil comprised sebum, perspiration, skin flakes, and other particulate matter, and hence is a blend of hydrophilic and hydrophobic body soils.

TABLE 2

| | Compo- | Compo- | Compo- | Compo- |
|---|---|---|---|---|
| | sition A* | sition B | sition C | sition D* |
| wt % MGDA | 0 | 30 | 15 | 0 |
| wt % Citric acid | 3.4 | 3.4 | 18.4 | 33.4 |
| | SRI | ΔSRI | ΔSRI | ΔSRI |
| Collar soil, knitted cotton | 69.6 | −0.1 | +10 | +6.7 |

*comparative

The test shows that the combination of the aminocarboxylic acid builder and one or more additional builders and/or chelants (citric acid in this case) results in an improved removal of combinations of hydrophilic and hydrophobic body soil, such as is typically found in collar and cuff stains.

### Example 2

The efficacy of laundry processes in which hydrophilic body soil stained fabric is washed using an aminocarboxylate builder having from 1 to 3 amino groups and 2 to 6 carboxylic acid groups (methylglycine diacetic acid, MGDA) in a first wash, followed by a subsequent second wash was evaluated as follows:

The test was carried out using identical professional washing machines (Electrolux W365H) and 6 kg of dry fabric load, using standardized stain swatches (stained cotton swatches, obtained from Equest Warwick Ltd or from Center For Test Materials BV) and a 3 kg mixed ballast load.

The following laundry additive composition (laundry composition E) was used for this comparative test:

TABLE 3
Laundry Composition E

| Ingredient | wt % |
|---|---|
| Methylglycine diacetic acid, trisodium salt (MGDA) | 15.0 |
| Citric acid | 15.0 |
| Sodium hydroxide | 6.5 * |
| Water and minors | To 100 |

* trimmed to pH 7.5

The following wash protocols were used:

In this test two consecutive washes were used, a first wash ran at 35° C., followed by a second wash at 60° C. A water hardness of 2.3 to 2.5 mmol/1(13-14° dH) was used for both washes. Comparative leg A consisted of the addition of 3 ml/kg dry laundry (i.e. 18 ml) of liquid composition A (commercial Ariel Liquid Detergent, Procter & Gamble professional System #1) in the first wash, followed by the second wash using 7 ml/kg dry laundry (i.e. 42 ml) of liquid composition A and 6 ml/kg dry laundry (i.e. 36 ml) of color safe liquid bleach (Procter & Gamble Professional System #3).

Comparative leg B was similar to Leg A, with the addition of 10 ml/Kg of dry laundry (i.e. 60 ml) of composition E in the second wash.

Leg B was similar to Leg A, with the addition of 10 ml/Kg of dry laundry (i.e. 60 ml) of composition E in the first wash.

TABLE 4

| | Leg A* | Leg B* | Leg C |
|---|---|---|---|
| | ml/kg dry | ml/kg dry | ml/kg dry |
| | fabric | fabric | fabric |
| First wash | | | |
| Laundry composition A | 3 | 3 | 3 |
| Laundry Additive E | — | — | 10 |
| Second wash | | | |
| Laundry composition A | 7 | 7 | 7 |
| Laundry Additive E | — | 10 | — |
| Bleach | 6 | 6 | 6 |

*comparative

As a result, the first wash and second wash comprised the following levels of citric acid and methylglycine diacetic acid, trisodium salt (MGDA):

TABLE 5

| | Leg A | Leg B | Leg C |
|---|---|---|---|
| | g | g | g |
| First wash | | | |
| Methylglycine diacetic acid, | — | — | 9 |
| trisodium salt (MGDA) | | | |
| Citric acid | 0.612 | 0.612 | 9.612 |
| Second wash | | | |
| Methylglycine diacetic acid, | — | 9 | — |
| trisodium salt (MGDA) | | | |
| Citric acid | 1.428 | 10.428 | 1.428 |
| Hydrophilic body soils: | SRI | ΔSRI | ΔSRI |
| Blood (aged) | 73.8 | +0.1 | +14.9 |
| Blood/milk/ink | 19.5 | +4.4 | +14.7 |
| Fecal | 61.5 | +5.8 | +11.5 |

Comparing Leg B with Leg A, adding the aminocarboxylic acid builder in the second wash which comprises surfactant and bleach at higher temperature (60 C) results in a moderate improvement in the removal of hydrophilic body soils.

As can be seen from comparing leg C with Leg A, adding the aminocarboxylic acid builder in the first wash results in a much greater improvement in the removal of hydrophilic body soils, even though the first wash was at a lower temperature of 35° C., and even when bleach is used in the subsequent wash.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for using from about 1 to about 50% by weight of an aminocarboxylate builder having from about 1 to about 3 amino groups and about 2 to about 6 carboxylic acid groups in a laundry composition for removing hydrophilic body soils.

2. The method according to claim 1, wherein the hydrophilic body soils is selected from the group consisting of: blood, menstrual fluid, urine, fecal, perspiration, vomit, mucus, and combinations thereof.

3. The method according to claim 1, wherein the hydrophilic body soil is blood.

4. The method, according to claim 1, wherein the carboxylate builder is selected from the group consisting of: glutamic acid N,N diacetic acid (GLDA), methylglycine diacectic acid (MGDA), ethylene diamine tetracetic acid (EDTA), diethyl triamine pentacetic acid (DTPA), nitrilo triacetic acid (NTA), ethylenediamine disuccinic acid (EDDS), imino disuccinic acid (IDS), iminodiacetic acid (IDA), ethanol diglycinate (EDG), aspartic acid N,N-diacetic acid (ASDA), hydroxyethylethylenediamine triacetate (HEDTA), hydroxyethyliminodisuccinate (HIDS), and mixtures thereof, preferably the carboxylate builder is selected from the group consisting of: N,N diacetic acid (GLDA), methylglycine diacectic acid (MGDA), and mixtures thereof.

5. The method, according to claim 1, wherein the carboxylate builder is present in a laundry composition at a level of from about 5 to about 40% by weight.

6. The method according to claim 1, wherein the laundry composition further comprises a laundry adjunct selected from the group consisting of: enzymes, detersive surfactants, cleaning polymer, additional builder or chelant, soil release polymer, whitening or blueing agent, antibacterial or disinfecting agent, solvent or stabilizer, perfume, dye or aesthetic additive, and mixtures thereof.

7. The method according to claim 6, wherein the laundry composition further comprises additional builder or chelant selected from the group consisting of: citric acid, aminoalkylenepoly(alkylene phosphonates), alkali metal ethane 1-hydroxy disphosphonates, and nitrilotrimethylene, phosphonates, diethylene triamine penta (methylene phosphonic acid) (DTPMP), ethylene diamine tetra(methylene phosphonic acid) (DDTMP), hexamethylene diamine tetra(methylene phosphonic acid), hydroxy-ethylene 1,1 diphosphonic acid (HEDP), hydroxyethane dimethylene phosphonic acid, catechol sulfonates and mixtures thereof.

8. The method according to claim 1, wherein the laundry composition has a pH of from about 5.0 to about 9.0.

9. The method according to claim 1, for removing hydrophilic body soils from fabrics comprising the steps of:
a) washing the fabrics in a first wash liquor, the first wash comprising a carboxylate builder selected from the group consisting of: aminocarboxylate builders having about 1 to about 3 amino groups and about 2 to about 6 carboxylic acid groups, and mixtures thereof; and water;
b) washing the fabrics in a second wash liquor comprising detersive surfactant.

10. The method of laundering fabrics according to claim 9, wherein the carboxylate builder is selected from the group consisting of: glutamic acid N,N diacetic acid (GLDA), methylglycine diacectic acid (MGDA), ethylene diamine tetracetic acid (EDTA), diethyl triamine pentacetic acid (DTPA), nitrilo triacetic acid (NTA), ethylenediamine disuccinic acid (EDDS), imino disuccinic acid (IDS), iminodiacetic acid (IDA), ethanol diglycinate (EDG), aspartic acid N,N-diacetic acid (ASDA), hydroxyethyliminodiacetate (HEIDA), and mixtures thereof.

11. The method of laundering fabrics according to claim 9, wherein the carboxylate builder is selected from the group consisting of N,N diacetic acid (GLDA), methylglycine diacectic acid (MGDA), and mixtures thereof.

12. The method of laundering fabrics according to claim 9, wherein the first wash liquor comprises the carboxylate builder at a level of from about 30 to about 10000 ppm.

13. The method of laundering fabrics according to claim 9, wherein the wash liquor further comprises one or more additional builders and/or chelants, selected from the group consisting of citric acid, and salts thereof.

14. The method of laundering fabrics according to claim 9, wherein the first wash liquor has a temperature of from about 10 to about 60° C.

15. The method of laundering fabrics according to claim 9, wherein the second wash liquor comprises surfactant at a level of from about 10 to about 3000 ppm.

16. A method of laundering fabrics according to claim 1, wherein the second wash liquor further comprises bleach.
